(19) United States
(12) Patent Application Publication
(10) Pub. No.: US 2023/0025835 A1
(43) Pub. Date: Jan. 26, 2023

(54) WORKFLOW GENERATION SUPPORT APPARATUS, WORKFLOW GENERATION SUPPORT METHOD AND WORKFLOW GENERATION SUPPORT PROGRAM

(71) Applicant: Nippon Telegraph and Telephone Corporation, Tokyo (JP)

(72) Inventors: Takaaki Moriya, Musashino-shi, Tokyo (JP); Manabu Nishio, Musashino-shi, Tokyo (JP)

(21) Appl. No.: 17/766,614

(22) PCT Filed: Oct. 25, 2019
(86) PCT No.: PCT/JP2019/041920

§ 371 Date: Apr. 5, 2022

(51) Int. Cl. G06Q 10/10; G06F 40/289

(52) U.S. Cl. CPC G06Q 10/103; G06F 40/289

(57) ABSTRACT

A business flow creation support device 1 includes a generation unit 11 that receives an effect and a sentence indicating what is desired to be realized, which are input by a user, and generates a flow including a plurality of clauses obtained by morphologically analyzing the sentence, a presentation unit 12 that acquires scores indicating to which fields the effect and words included in the clauses are close, respectively, and presents, to the user, a template of a business flow in a field having a high total score, and a creation support unit 14 that support creation of the business flow corresponding to the effect and the sentence.

### TECHNICAL FIELD

The present invention relates to a business flow creation support device, a business flow creation support method, and a business flow creation support program.

### BACKGROUND ART

One of the methods to express the flow of business (work) is a business flow. As a technique related to this business flow, Patent Literature 1 describes generating a business process diagram from a standardized document that defines a system design in an upstream process of system development.

In addition, Patent Literature 2 describes receiving business process information and access information based on a work flow to generate a rule table that restricts access to the information.

### CITATION LIST

### Patent Literature

Patent Literature 1: Japanese Patent Laid-Open No. 2016-218851
Patent Literature 2: Japanese Patent Laid-Open No. 2015-153139

### SUMMARY OF THE INVENTION

### Technical Problem

Recently, the AI (Artificial Intelligence) has been attracting attention, and there is a growing need of desiring to carry out a business reform by the AI. A person in charge of a site who is considering introduction of the AI creates a proposal for a business reform and presents the proposal to a data scientist who examines how to solve problems so as to solve the problems in collaboration. It is necessary to describe a “business flow after introduction of the AI” in the proposal.

The AI includes a variety of fields, and there are terms and typical business flows that are frequently used in each field. For the person in charge of a site who is not familiar with the AI, however, it is not easy to create a business flow after grasping all of them.

In addition, today, various technological innovations other than the AI are being made, and it is not easy for the person in charge of a site, who is considering introduction of a new technology, to create a business flow if the person in charge is not familiar with the technology.

The present invention has been made in view of the above circumstances, and an object of the present invention is to provide a technique for supporting a user even if the user is not familiar with a technology to be introduced so that a business flow can be easily created.

### Means for Solving the Problem

In order to achieve the above object, one aspect of the present invention is a business flow creation support device, including a generation unit that receives an effect and a sentence indicating what is desired to be realized, which are input by a user, and generates a flow including a plurality of clauses obtained by morphologically analyzing the sentence, a presentation unit that acquires scores indicating to which fields the effect and words included in the clauses are close, respectively, and presents, to the user, a template of a business flow in a field having a high total score, and a creation support unit that supports creation of the business flow corresponding to the effect and the sentence.

One aspect of the present invention is a business flow creation support method performed by a business flow support device, which executes a generation step of receiving an effect and a sentence indicating what is desired to be realized, which are input by a user, and generating a flow including a plurality of clauses obtained by morphologically analyzing the sentence, a presentation step of acquiring scores indicating to which fields the effect and words included in the clauses are close, respectively, and presenting, to the user, a template of a business flow in a field having a high total score, and a creation support step of supporting creation of the business flow corresponding to the effect and the sentence.

One aspect of the present invention is a business flow creation support program that causes a computer to function as the business flow creation support device.

### Effects of the Invention

According to the present invention, it is possible to provide a technique for supporting a user even if the user is not familiar with a technology to be introduced so that a business flow can be easily created.

### BRIEF DESCRIPTION OF DRAWINGS

FIG. 1 is an explanatory diagram for describing an outline of an embodiment of the present invention.

FIG. 2 is a block diagram showing a configuration of a business flow creation support device of the embodiment of the present invention.

FIG. 3 is an example of a template storage unit.

FIG. 4 is an example of an effect score storage unit.

FIG. 5 is an example of a word score storage unit.

FIG. 6 is an example of a related element storage unit.

FIG. 7 is a flowchart showing an operation of the business flow creation support device.

FIG. 8 is an example of a screen displayed on a user terminal.

FIG. 9 is an example of a screen displayed on the user terminal.

FIG. 10 is an example of the calculation result of the total score in each field.

FIG. 11 is a diagram in which effects and words are mapped to the close fields according to the scores.

FIG. 12 is an example of a screen for prompting correction of a word.

FIG. 13 is an example of a screen displayed on the user terminal.

FIG. 14 is an example of a screen displayed on the user terminal.

FIG. 15 is an example of a screen displayed on the user terminal.

FIG. 16 is an explanatory diagram for describing automatic generation in the word score storage unit.

FIG. 17 is an example of mapping information in which the fields and algorithms are associated with each other.

FIG. 18 is an example of a screen when a business flow in civil engineering is created.

FIG. 19 is an example of a hardware configuration.

### DESCRIPTION OF EMBODIMENTS

Hereinafter, embodiments of the present invention will be described with reference to the drawings.

### Outline of the Present Embodiment

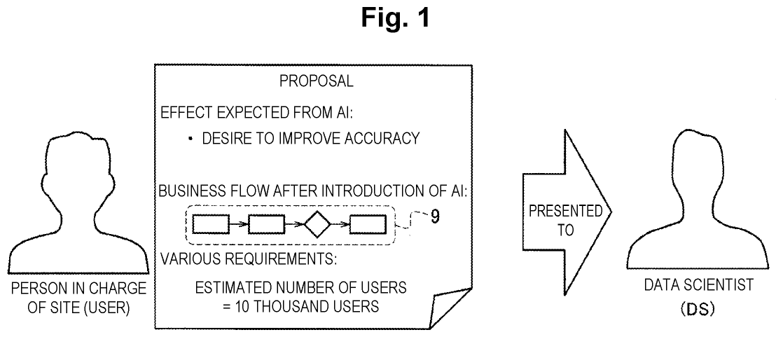

FIG. 1 is an explanatory diagram for describing an outline of the present embodiment. The present embodiment supports creation of a business flow after introduction of the AI when a business reform is carried out by the AI.

In an illustrated example, a user (a person in charge of a site) who is considering introduction of the AI creates a proposal for a business reform and presents the proposal to a data scientist (hereinafter referred to as the “DS”) so as to solve problems of the present business in collaboration with the DS. The DS uses big data analysis and statistics to provide information necessary for a business strategy of the company.

In the proposal, it is necessary to describe, for example, an effect expected from the AI, a business flow 9 after introduction of the AI, various requirements, and the like. Since it is not easy for the user who is not familiar with the AI to create the business flow 9, the present embodiment supports creation of the business flow 9 so that the user can easily create the appropriate business flow 9. By presenting the business flow 9 to the DS, the user can proceed with the business reform by the AI in collaboration with the DS.

It should be noted that in the present embodiment, creation of the business flow after introduction of the AI is supported when a business reform is carried out by the AI, but the business flow whose creation is supported by the present invention is not limited to the AI.

(Configuration of Business Flow Creation Support Device)

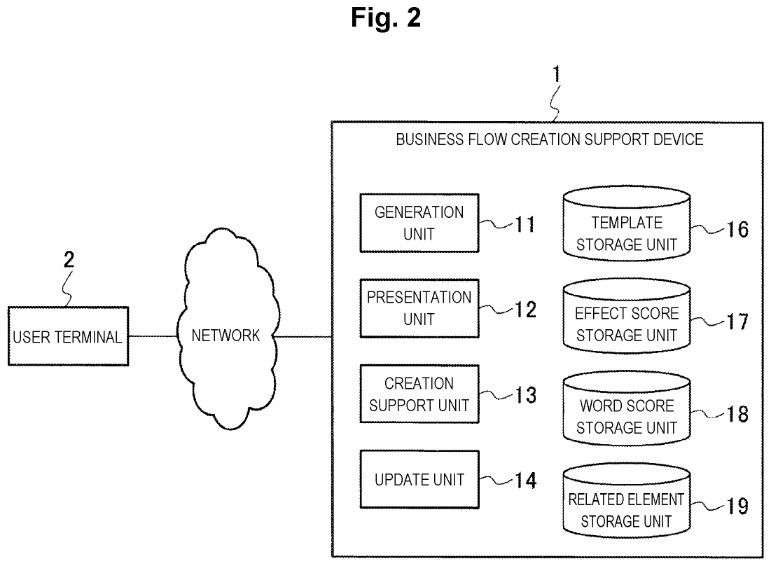

FIG. 2 is a configuration example of a business flow creation support device 1 of the present embodiment. The illustrated business flow creation support device 1 is connected to a user terminal 2 via a network so as to be able to communicate with the user terminal 2. The user terminal 2 is, for example, a terminal device such as a PC (personal computer), a tablet terminal, or a smartphone.

The business flow creation support device 1 is a device that supports a user to create a business flow. The illustrated business flow creation support device 1 includes a generation unit 11, a presentation unit 12, a creation support unit 13, an update unit 14, a template storage unit 16, an effect score storage unit 17, a word score storage unit 18, and a related element storage unit 19.

The generation unit 11 receives an effect and a sentence indicating what is desired to be realized, which are input by the user, and generates a flow including a plurality of clauses obtained by morphologically analyzing the sentence. The generation unit 11 of the present embodiment receives an effect expected from the AI and a sentence indicating what is desired to be realized by the AI and generates a flow. In addition, when there is a word that does not exist in the word score storage unit 18 among words included in the clauses, the generation unit 11 presents, to the user, a word that is a synonym of the word and exists in the word score storage unit 18 to prompt correction.

The presentation unit 12 acquires scores indicating to which fields the effect and the words included in the clauses are close, respectively, and presents, to the user, a template of a business flow in the field having a high total score. In addition, the presentation unit 12 of the present embodiment presents, to the user, a template of a business flow in the field of the AI having a high total score.

The creation support unit 13 receives an editing operation by the user for the flow generated by the generation unit 11 and the presented template and supports creation of the business flow corresponding to the input effect and sentence. When a predetermined partial flow is included in the business flow corresponding to the effect and the sentence input by the user, the creation support unit 13 presents, to the user, a related element related to the partial flow.

The update unit 14 updates the scores of the words included in the clauses of the word score storage unit 18 by using the scores of the effect input by the user in the effect score storage unit 17.

The template storage unit 16 stores a template of the business flow for each AI field. The effect score storage unit 17 stores, for each effect expected from the AI, a score indicating to which field of the AI the effect is close. The word score storage unit 18 stores, for each word, a score indicating to which field the word is close. The related element storage unit 19 stores, for each partial flow that is a part of the flow, a related element related to the partial flow.

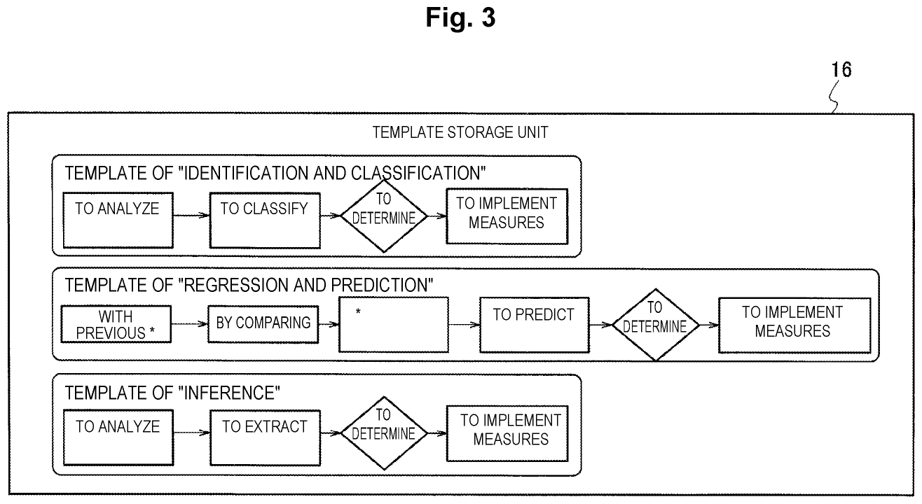

FIG. 3 is a diagram showing an example of templates stored in the template storage unit 16. In the illustrated template storage unit 16, the templates of the business flows are stored in association with respective fields (“identification and classification”, “regression and prediction”, and “inference”).

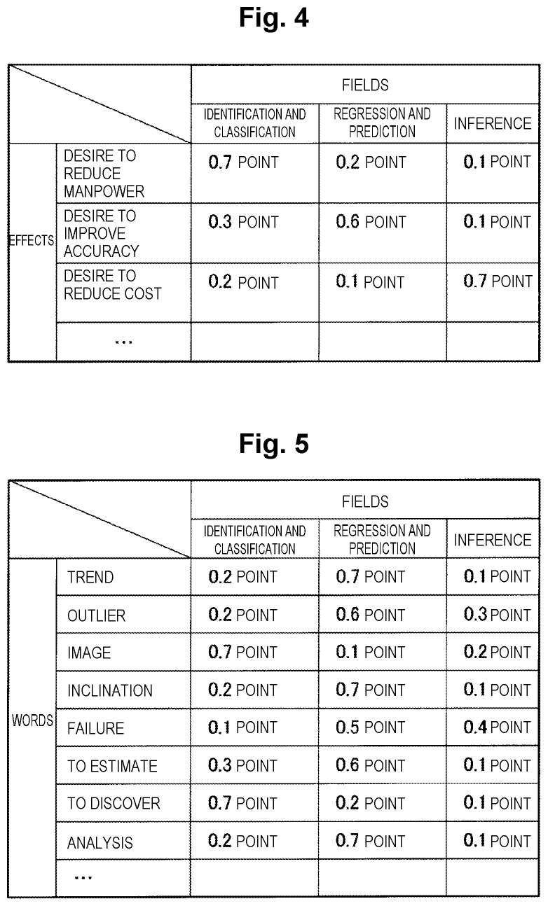

FIG. 4 is a diagram showing an example of effect scores stored in the effect score storage unit 17. The illustrated effect scores are shown in a form of a table, in which a score for each field is set for each effect. The score is an index showing to which field the effect is close. In an illustrated example, with respect to an effect of “desire to reduce manpower”, the scores in the respective fields (“identification and classification”, “regression and prediction”, and “inference”) are “0.7”, “0.2”, and “0.1”, respectively. Therefore, it is shown that the effect of “desire to reduce manpower” is close to the field of “identification and classification” having the highest score (0.7). It is shown that the effect of “desire to improve accuracy” is close to the field of “regression and prediction” having the highest score (0.6).

FIG. 5 is a diagram showing an example of word scores stored in the word score storage unit 18. The illustrated word scores are shown in a form of a table, in which a score for each field is set for each word. The score is an index showing to which field the word is close. For example, with respect to a word “trend”, the scores in the respective fields (“identification and classification”, “regression and prediction”, and “inference”) are “0.2”, “0.7”, and “0.1”, respectively. Therefore, it is shown that the word “trend” is close to the field of “regression and prediction” having the highest score (0.7).

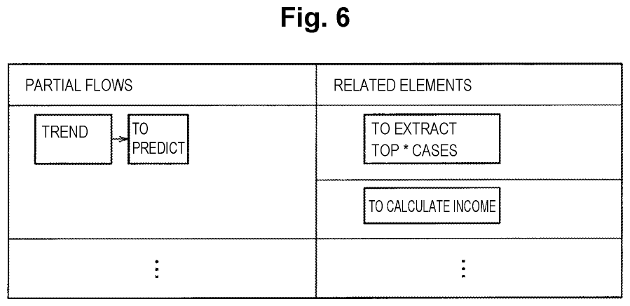

FIG. 6 is a diagram showing an example of related elements stored in the related element storage unit 19. The illustrated related element storage unit 19 stores at least one related element in association with each predetermined partial flow.

(Operation of Business Flow Creation Support Device)

Hereinafter, an operation of the business flow creation support device 1 of the present embodiment will be described.

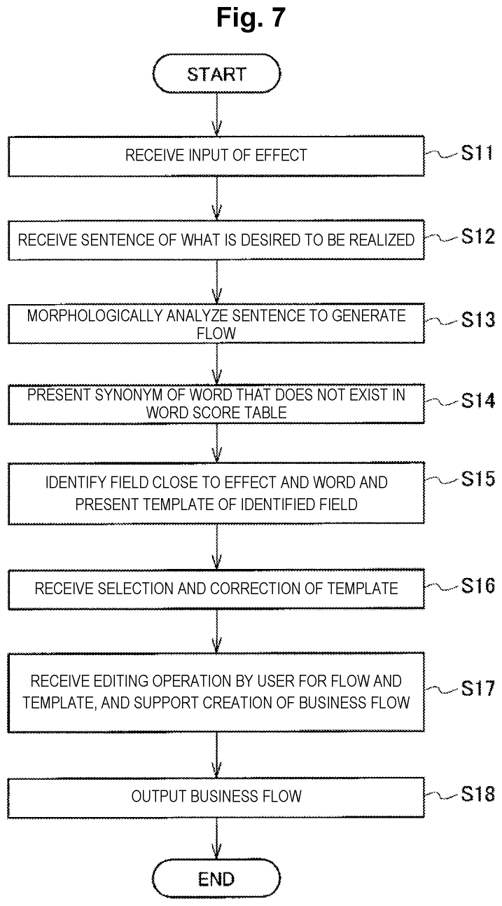

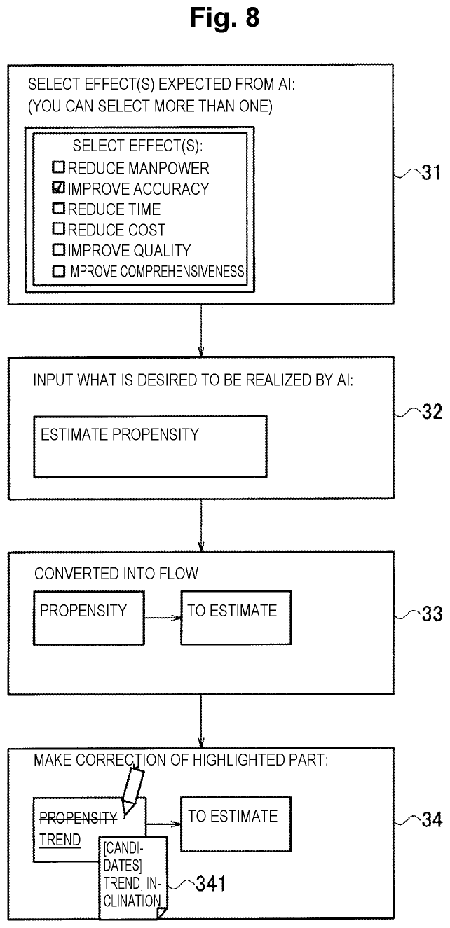

FIG. 7 is a flowchart showing the operation of the business flow creation support device 1. FIGS. 8, 9, 12-15 are diagrams each showing an example of a screen displayed on a display of the user terminal 2.

The business flow creation support device 1 receives an effect input by the user (S11). For example, the business flow creation support device 1 transmits a screen 31 of FIG. 8 to the user terminal 2 to present a plurality of effects to the user, and causes the user to select the effect. Then, the business flow creation support device 1 receives the effect selected by the user (here, “improve accuracy”) from the user terminal 2. Since the effects of the AI are simple to understand, the user can easily select a desired effect.

Then, the business flow creation support device 1 receives a sentence (or sentences) of “what is desired to be realized by the AI” input by the user (S12). For example, the business flow creation support device 1 transmits a screen 32 of FIG. 8 to the user terminal 2, and receives the sentence input by the user (here, “estimate propensity”) from the user terminal 2. The user freely describes “what is desired to be realized by the AI” in an input field on the screen.

Then, the business flow creation support device 1 morphologically analyzes the sentence input by the user, generates a flow including a plurality of clauses, and transmits the flow to the user terminal 2 so that the flow is presented to the user (S13). In other words, the business flow creation support device 1 converts the sentence input by the user into the flow. Specifically, as shown on a screen 33 of FIG. 8, the business flow creation support device 1 divides the sentence input by the user into a plurality of clauses, assigns one processing box (processing step) to each clause, and connects each processing box with an arrow to generate the flow.

Then, when there is a word that does not exist in the word score storage unit 18 among the words included in the clauses, the business flow creation support device 1 transmits, to the user terminal 2, a word that is a synonym of the word and is a correction candidate existing in the word score storage unit 18, and prompts the user to correct the word (S14). For example, as shown on a screen 34 of FIG. 8, the business flow creation support device 1 presents words 341, which are correction candidates (here, “trend”, “inclination”) of the word that does not exist in the word score storage unit 18 (here, “propensity”).

It should be noted that the business flow creation support device 1 acquires the synonym by referring to a synonym dictionary (not shown) provided in the business flow creation support device 1. It is assumed that the user inputs “propensity” and there are “trend”, “inclination”, and “prejudice” as the synonyms of “propensity” in the synonym dictionary. When “trend” and “inclination” exist in the word score storage unit 18 shown in FIG. 5, the business flow creation support device 1 presents, to the user, only “trend” and “inclination” that exist in the word score storage unit 18 as the correction candidate words for “propensity”. By presenting the words of the correction candidates, it is possible to eliminate a fluctuation of the words in the sentence freely described by the user. S14 is not a mandatory process, and the business flow creation support device 1 may omit S14.

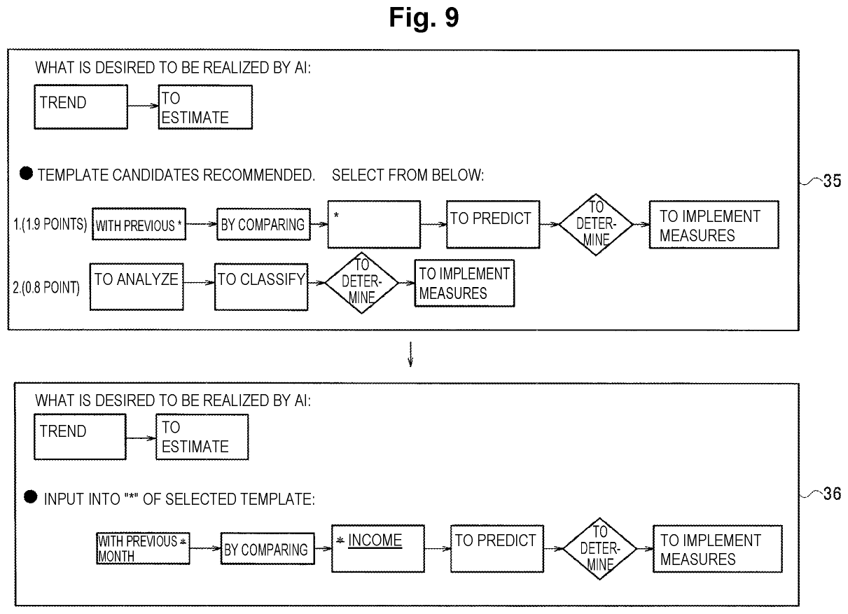

Then, the business flow creation support device 1 identifies a field close to (highly related to) the effect of S11 and the word of the generated flow, transmits a template of the business flow in the identified field to the user terminal 2 to recommend the template to the user (S15). For example, the business flow creation support device 1 transmits a screen 35 of FIG. 9 to the user terminal 2. The screen 35 displays templates in two fields each having a high total score (relevance score), and recommends the templates to the user. In an illustrated example, the templates in the two fields each having the high total score are set in descending order of the total score.

Here, the business flow creation support device 1 calculates the total score by using the scores of the effect score storage unit 17 and the word score storage unit 18. Specifically, the business flow creation support device 1 acquires a score indicating to which field each effect and each word input by the user is close for each field, and calculates the total score for each field.

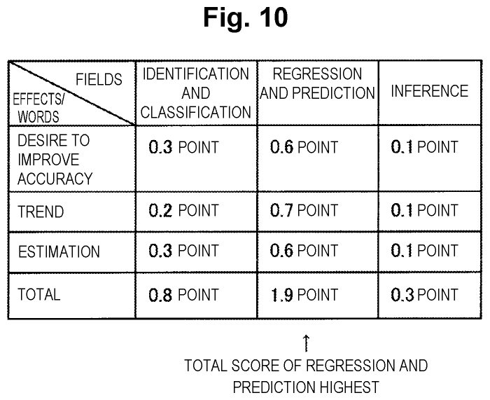

FIG. 10 is a calculation result of the total score in each field when the effect scores and the word scores shown in FIGS. 4 and 5 are used. The business flow creation support device 1 calculates the total score of the scores acquired for the respective fields by acquiring a score to which the effect score corresponds for each field with respect to the effect (desire to improve accuracy) and by acquiring a score to which the word score corresponds for each filed with respect to the word (trend, estimation). It should be noted that in the present embodiment, three fields of “identification and classification”, “regression and prediction”, and “inference” are exemplified as the fields, but the fields are not limited to these.

In an illustrated example, since the total score of “regression and prediction” is the highest, the business flow creation support device 1 determines that the field closest to the effect and the word specified by the user is “regression and prediction”. In the present embodiment, the business flow creation support device 1 acquires, from the template storage unit 16, templates of two fields (“regression and prediction” and “identification and classification”) each having a high total score and sets the templates along with the total scores on the screen 35 of FIG. 9.

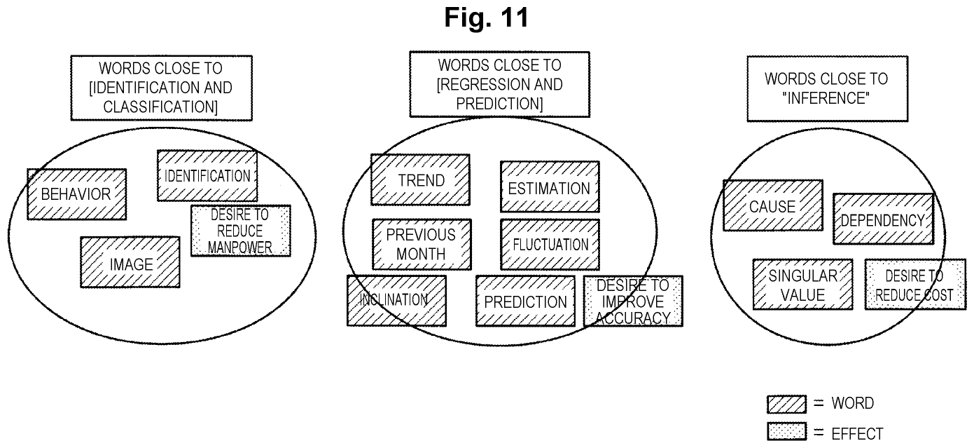

FIG. 11 is a diagram in which each “effect” set to the effect score shown in FIG. 4 and each “word” set to the word score shown in FIG. 5 are mapped to close fields (related fields) according to the scores. Each effect and each word are given points for each of the plurality of fields as shown in FIGS. 4 and 5. However, for the sake of clarity, in FIG. 11, each effect and each word are described for convenience as belonging to only one field having the highest score. In an illustrated example, the effect close to the field of “regression and prediction” is “desire to improve accuracy”, and the words close to the field are “trend”, “estimation”, “previous month”, and the like.

The business flow creation support device 1 may prompt the user to correct a word when the field of the word included in the flow is different from the field to which the effect input by the user belongs.

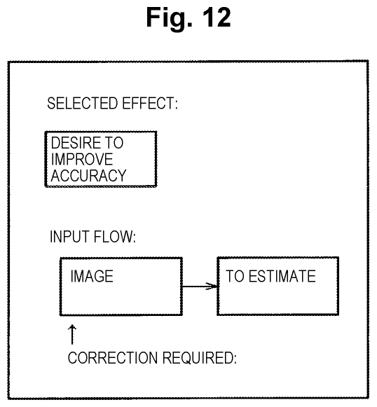

FIG. 12 is an example of a screen transmitted by the business flow creation support device 1 to the user terminal 2 in order to prompt correction of the word. In FIG. 11, “desire to improve accuracy” belongs to the field of “regression and prediction”, but “image” belongs to “identification and classification”. Thus, on the screen of FIG. 12, the field to which the effect belongs and the field to which the word belongs are different. When the field to which the effect belongs and the field to which the word belongs are different, the business flow creation support device 1 determines that the input made by the user is inconsistent (wrong) and prompts the user to correct “image”.

Thereby, in the present embodiment, it is possible to support the user to express the flow and system requirements in accurate terms, and as a result, to create an appropriate business flow intended by the user. As a result, the user can present the appropriate business flow to the DS, which makes it possible to facilitate communication between the DS and the user.

Then, the business flow creation support device 1 receives selection and correction of the template by the user (S16). A screen 36 of FIG. 9 is a screen that is transmitted by the business flow creation support device 1 to the user terminal 2 when the user selects the template of “regression and prediction” having the highest total scores. In addition, on the screen 36, the user is prompted to manually correct a “*” (wildcard character) part in the template.

Then, the business flow creation support device 1 receives an editing operation by the user for the flow and the template, and supports the creation of the business flow (S17).

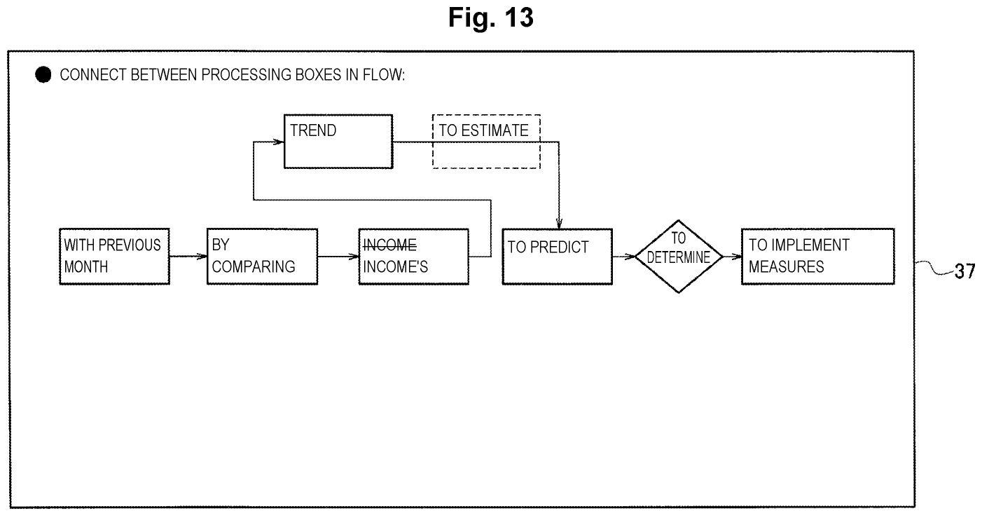

FIG. 13 is a diagram showing an example of a screen 37 during the editing operation for the flow by the user. The screen 37 instructs the user to create a business flow by connecting between the flow and the templates. In an illustrated example, the user creates the business flow in which the flow and the templates are integrated by connecting “income” in the template to “trend” of in the flow and by connecting “trend” in the flow to “to predict” in the template each with an arrow on a GUI. Thereby, “to estimate” in the flow is deleted. In addition, the user may also correct “income” to “income's”.

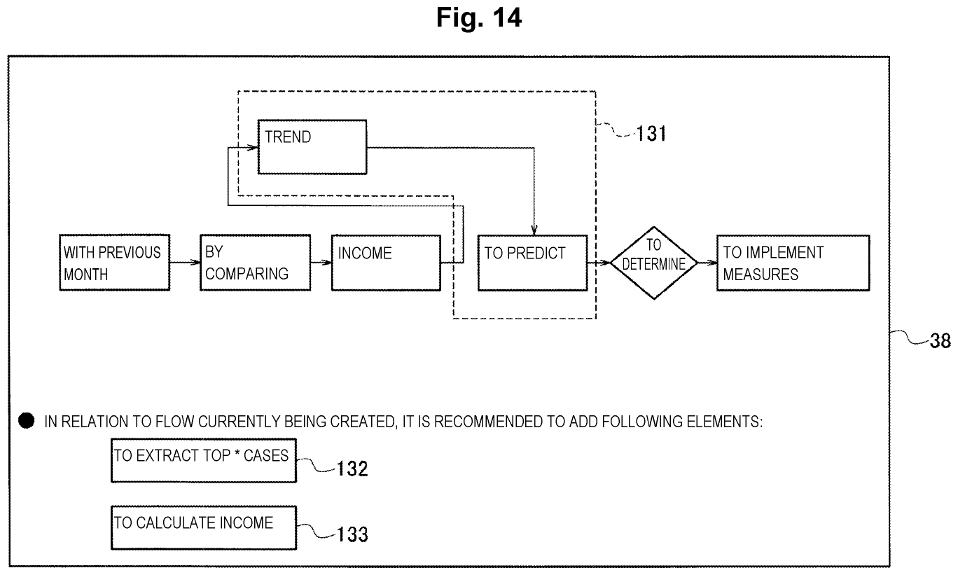

FIG. 14 is a diagram showing an example of the screen 38 during the editing operation by the user. The business flow creation support device 1 analyzes the business flow during the editing operation by the user in real time. Then, when a predetermined partial flow is included in the business flow, the business flow creation support device 1 displays a related element related to the partial flow on the screen 38 so that the related element is presented to the user. Specifically, the business flow creation support device 1 determines in real time whether or not any of the partial flows stored in the related element storage unit 19 exists in the business flow. Then, if such partial flow exists, the business flow creation support device 1 transmits, to the user terminal 2, the screen 38 on which the corresponding related element is set so that the screen 38 is presented to the user.

In an illustrated example, since a predetermined partial flow 131 (from “trend” to “to infer”) is stored in the related element storage unit 19, the business flow creation support device 1 displays corresponding related elements 132 and 133 on the screen 38. It should be noted that the business flow creation support device 1 may set the related elements on the screen in descending order of the number of times the user has actually used. In this case, the business flow creation support device 1 counts the number of times each related elements is used and holds the number in the related element storage unit 19.

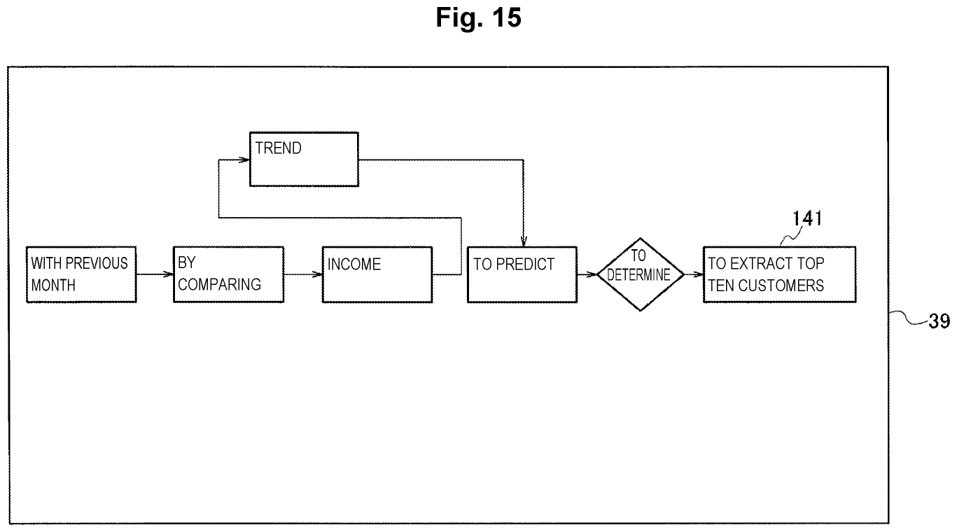

FIG. 15 is an example of a screen showing the result in which the user has edited the business flow by using the related element. In an illustrated example, the user selects a related element 132 (“to extract the top*items”) recommended in FIG. 14, drags the related element 132 on the GUI, and places the related element 132 at a desired position 141 in the business flow. Thereby, the business flow creation support device 1 replaces “to implement measures” with “to extract top*cases” in the business flow. Then, the user manually corrects “*” of the related element into a predetermined character.

By the above processing, the business flow creation support device 1 creates the business flow by supporting the user to create the business flow. Then, the business flow creation support device 1 stores the created business flow in a storage unit (not shown) and transmits (outputs) the created business flow to the user terminal 2 (S18). In addition, the business flow creation support device 1 may generate a proposal including the business flow, store the proposal in the storage unit, and transmit the proposal to the user terminal 2. As shown in FIG. 1, the proposal may include, for example, “an effect expected from the AI”, “a business flow”, “various requirements”, and the like.

(Generation of Word Score)

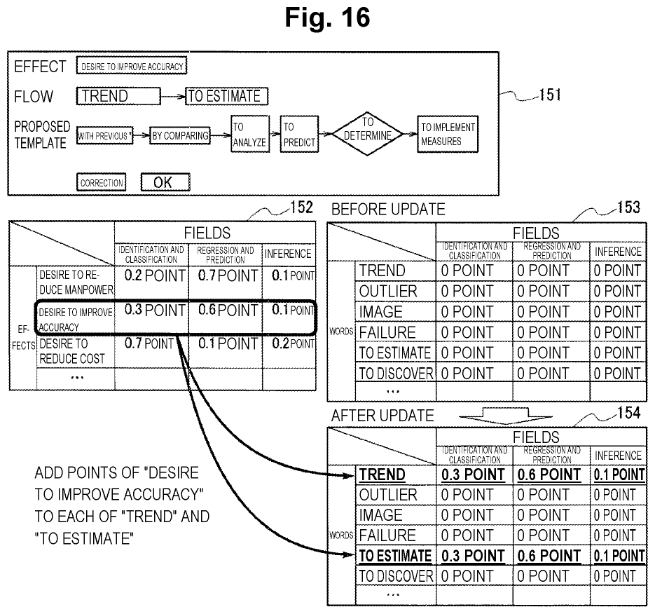

FIG. 16 is an explanatory diagram for describing automatic generation (learning) of a score of the word score storage unit 18. It is assumed that the score of the effect score storage unit 17 has been created in advance.

On an illustrated screen 151, “desire to improve accuracy” is input as the effect, and [from “trend” to “to estimate”] is input as the flow. In this case, the business flow creation support device 1 adds the score for each field, which is set in the row of “desire to improve accuracy” of the effect score table 152, to the scores of the words (“trend”, “to estimate”), which correspond to the flow, in the word score tables 153, 154.

Specifically, the score of the effect for each field is added to each score (0 point) for each field of “trend” and “to estimate” in the word score table 153 before update. Then, each score for each field of “trend” and “to estimate” in the word score table 154 after update becomes 0.3 points, 0.6 points, and 0.1 points. It should be noted that the business flow creation support device 1 updates the word scores as described above after S13 in FIG. 7.

In addition, the business flow creation support device 1 may update the score in the effect score storage unit 17. For example, the business flow creation support device 1 transmits a screen 151 illustrated in S15 of FIG. 7 to the user terminal 2. The user clicks “OK” if the proposed template on the screen 151 is good, or clicks “CORRECTION” to request another template if the proposed template thereon is not good. On the screen 151, the template of “regression and prediction” is displayed for the effect of “desire to improve accuracy”. When the user clicks “CORRECTION”, the business flow creation support device 1 may lower, by a predetermined value a, the score of the field (“regression and prediction”) of the proposed template for “desire to improve accuracy” in the effect score table 152. Specifically, the business flow creation support device 1 may deduct a points from the score of 0.6 point of “regression and prediction” of “desire to improve accuracy” in the effect score table 152.

### Modified Example 1

It should be noted that the business flow creation support device 1 holds, in a storage unit of the business flow creation support device 1, mapping information in which each field and an algorithm corresponding to each field are associated with each other. When a template is selected on the screen 35 in FIG. 9, an algorithm corresponding to the field of the selected template may be set on a screen after the template is selected so that the template is presented to the user.

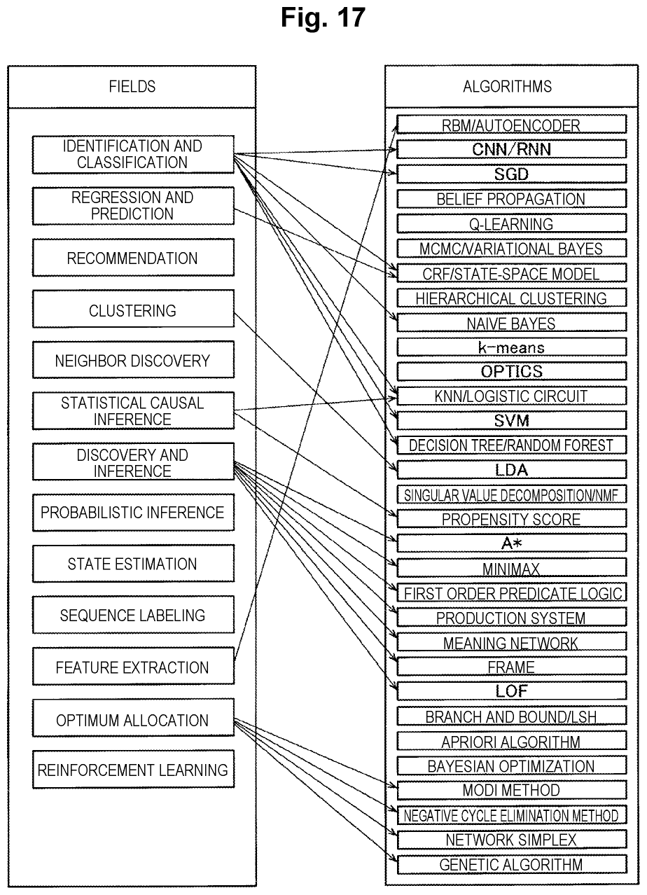

FIG. 17 shows an example of the mapping information registered in advance in the business flow creation support device 1. For example, algorithms such as “CNN/RNN” and “SGD” are associated with the field of “identification and classification”. When the user selects a template for “identification and classification”, the business flow creation support device 1 sets the names of the algorithms such as “CNN/RNN” and “SGD”, for example, on screens 36 to 39 of FIGS. 9 and 13 to 15 so that the names of the algorithms are presented to the user.

It is expected that this will help the user understand the algorithms and develop a conversation in such a manner that the user asks the DS a question, asking the DS to tell the user about the XX algorithm.

### Modified Example 2

In the above embodiment, creation of the business flow after introduction of the AI is supported when a business reform is carried out by the AI, but the business flow whose creation is supported by the present invention is not limited to the AI. The present invention is applicable, for example, when the business flow is created in various industries such as civil engineering and publishing.

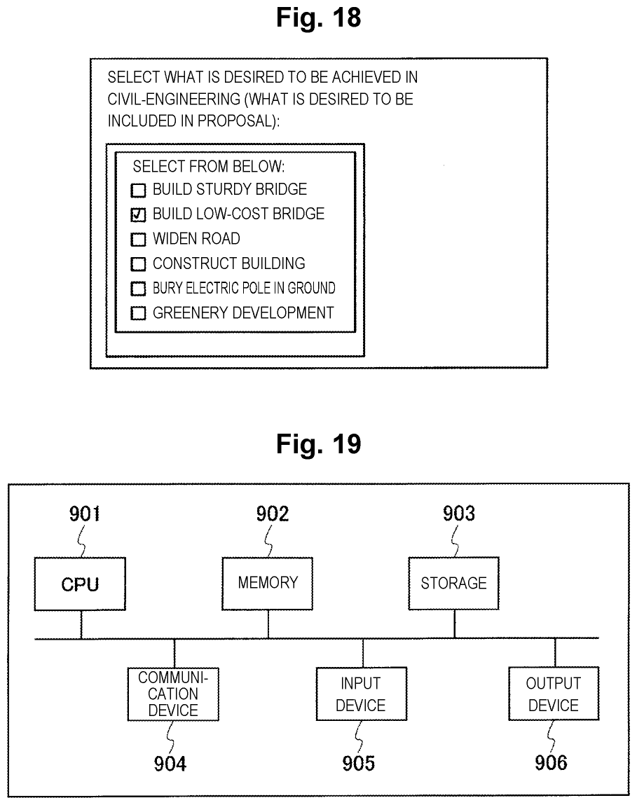

FIG. 18 is an example of a screen presented to the user when a business flow is created in civil engineering.

### Effect of the Present Embodiment

The business flow creation support device 1 of the present embodiment described above includes a generation unit 11 that receives an effect and a sentence indicating what is desired to be realized, which are input by a user, and generates a flow including a plurality of clauses obtained by morphologically analyzing the sentence, a presentation unit 12 that acquires scores indicating to which fields the effect and words included in the clauses are close, respectively, and presents, to the user, a template of a business flow in a field having a high total score, and a creation support unit 13 that receives an editing operation by the user for the flow and the template and supports creation of the business flow corresponding to the effect and the sentence.

Thereby, the present embodiment can support a user so that a business flow can be easily created even if the user is not familiar with the technology to be introduced. For example, it is possible to support a user, who is considering introduction of the AI, so that a business flow after introduction of the AI can be easily created even if the user is not familiar with the AI. Specifically, the present embodiment can support creation of a business flow by drawing out, from a user, what is desired to be realized by the AI, identifying the field of the AI technology to be applied, and recommending a template according to the identified field.

Therefore, a user who creates a proposal or the like on a business reform can easily create a business flow without knowledge of the terms and the typical business flows used in each field of the AI, and clearly communicate the business flow after introduction of the AI to a data scientist who examines how to solve problems. In addition, a user can easily create a proposal including a business flow, an effect, and the like.

(Hardware Configurations of Distributed Processing Device and DB Device)

In the business flow creation support device 1 described above, a general-purpose computer system as shown in FIG. 19, for example, can be used. The illustrated computer system includes a CPU (Central Processing Unit, processor) 901, a memory 902, a storage 903 (HDD: Hard Disk Drive, SSD: Solid State Drive), a communication device 904, an input device 905, and an output device 906. The memory 902 and the storage 903 are storage devices. In this computer system, each function of the business flow creation support device 1 is realized by executing a predetermined program loaded on the memory 902 by the CPU 901.

In addition, the business flow creation support device 1 may be implemented by one computer, or may be implemented by a plurality of computers. In addition, the business flow creation support device 1 may be a virtual machine mounted on a computer.

The program for the business flow creation support device 1 can be stored in a computer-readable recording medium such as a HDD, an SSD, a USB (Universal Serial Bus) memory, a CD (Compact Disc), or a DVD (Digital Versatile Disc). Alternatively, the program can also be delivered via a network.

It should be noted that the present invention is not limited to the embodiment and modified examples described above, and a number of modifications can be made within the scope of the gist thereof. For example, the business flow creation support device 1 of the above embodiment may be connected to the user terminal 2 via a network, and the user may access the business flow creation support device 1 via the user terminal 2. Nevertheless, the business flow creation support device 1 may be a terminal used by a user such as a PC (Personal Computer), a tablet terminal, or a smartphone.

### REFERENCE SIGNS LIST

1 Business flow creation support device
11 Generation unit
12 Presentation unit
13 Creation support unit
14 Update unit
16 Template storage unit
17 Effect score storage unit
18 Word score storage unit
19 Related element storage unit
2 User Terminal

1. A flow creation support device, comprising:
a generation unit, including one or more processors, that receives an effect and a sentence indicating what is to be realized, which are input by a user, and generates a flow including a plurality of clauses obtained by morphologically analyzing the sentence;
a presentation unit, including one or more processors, that acquires scores indicating to which fields the effect and words included in the clauses are relevant, respectively, and presents, to the user, a template of a flow in a field having a high total score; and
a creation support unit, including one or more processors, that supports creation of the flow corresponding to the effect and the sentence.

2. The flow creation support device according to claim 1, wherein:
the creation support unit receives an editing operation by the user for the flow and the template and supports the creation of the flow corresponding to the effect and sentence.

3. The flow creation support device according to claim 1, wherein:
the generation unit receives the effect expected from artificial intelligence (AI) and the sentence indicating what is to be realized by the AI and generates the flow; and
the presentation unit presents, to the user, a template of a flow in a field of the AI having the high total score.

4. The flow creation support device according to claim 1, further comprising:
a word score storage unit, including one or more processors, that stores, for each word, a score indicating to which field the word is relevant;
an effect score storage unit, including one or more processors, that stores, for each effect, a score indicating to which field the effect is relevant; and
an update unit, including one or more processors that updates the scores of the words included in the clauses of the word score storage unit by using the scores of the effect input by the user in the effect score storage unit.

5. The flow creation support device according to claim 4, wherein:
when there is a word that does not exist in the word score storage unit among the words included in the clauses, the generation unit presents, to the user, a word that is a synonym of the word and exists in the word score storage unit to prompt correction.

6. The flow creation support device according to claim 1, wherein:
the creation support unit presents, when a predetermined partial flow is included in the flow corresponding to the effect and the sentence, a related element related to the predetermined partial flow to the user.

7. A flow creation support method performed by a flow support device, comprising:
receiving an effect and a sentence indicating what is to be realized, which are input by a user;
generating a flow including a plurality of clauses obtained by morphologically analyzing the sentence;
acquiring scores indicating to which fields the effect and words included in the clauses are relevant, respectively;
presenting, to the user, a template of a business flow in a field having a high total score; and
supporting creation of the flow corresponding to the effect and the sentence.

8. A non-transitory computer readable medium comprising a flow creation support program for causing a computer to function as a flow creation support device comprising:
a generation unit that receives an effect and a sentence indicating what is to be realized, which are input by a user, and generates a flow including a plurality of clauses obtained by morphologically analyzing the sentence;
a presentation unit that acquires scores indicating to which fields the effect and words included in the clauses are relevant, respectively, and presents, to the user, a template of a flow in a field having a high total score; and
a creation support unit that supports creation of the flow corresponding to the effect and the sentence.
